(19) United States
(12) Patent Application Publication
(10) Pub. No.: US 2020/0372585 A1
(43) Pub. Date: Nov. 26, 2020

(54) SYSTEMS AND METHODS FOR GENERATING CRITERIA-BASED EVENTS WITHIN A GEOGRAPHICAL AREA

(71) Applicant: PAG Financial International LLC, Guaynabo, PR (US)

(72) Inventors: Pavan Agarwal, Arcadia, CA (US); Gabriel Albors Sanchez, Arcadia, CA (US); Jonathan Ortiz Rivera, Arcadia, CA (US)

(21) Appl. No.: 16/419,526

(22) Filed: May 22, 2019

(51) Int. Cl. G06Q 50/00; G06Q 10/10

(52) U.S. Cl. CPC G06Q 50/01; G06Q 10/1095

(57) ABSTRACT

Systems and methods are provided for generating events based on one or more user specified parameters within a geographical area. An event may be generated based on an event location, an event time, and event type, and a participation requirement specified by the event organizer. A potential event participant may receive a notification of the event. A potential event participant may be enrolled in the event upon determining event eligibility of potential event participant.

### TECHNICAL FIELD

The present disclosure is generally related to organizing events. More particularly, the present disclosure is directed to systems and methods for generating events open to qualifying participants within a geographical area.

### BACKGROUND

The rise of internet-connected smartphones has made it easier than ever before to spend time with friends and family. Despite being connected to a large number of people, many find it difficult to organize and plan events in the real world. This is especially true for planning events focused on a particular activity that demands a certain skill level. For example, adults that are interested in playing sports have a hard time finding other like-minded individuals who are not only interested in participating in a particular activity or an event but who also possess a level of skill required to join the activity.

Typically, a number of social media platforms may offer users a variety of event scheduling capabilities. However, users have struggled with admitting only those participants whose abilities and/or skill level have been verified. Accordingly, a user may be required to sacrifice desired features when scheduling and managing events. There is an ongoing need for improved systems and methods to allow users to organize events by not only specifying event planning details such as time, location, and activity type, but also specifying entry requirements by specifying participant skill level and determining participant eligibility based on information provided by participants.

### SUMMARY

In accordance with one or more embodiments, various features and functionality can be provided to enable or otherwise facilitate a generating events based on one or more user specified parameters within a geographical area.

In some embodiments, an event system may be configured to receive event information corresponding to an event and specifying a set of user-specific parameters For example, the event system may receive event information sent by a user (e.g., event organizer) via an event application. In some embodiments, the event system may be configured to generate an event based on the set of user-specific parameters received from the first user.

In some embodiments, the set of user-specific parameters comprise an event location, an event time, and event type, and a participation requirement specified by the event organizer. In some embodiments, the event system may receive real-world location information specifying a real-world location of the event organizer. In some embodiments, the event location may be determined based on a real world location of the event organizer.

In some embodiments, the system may send a notification comprising the event information to another user (e.g., potential event participant) notifying that user of the event.

In some embodiments, the event system may be configured to receive an enrollment request from the potential event participant who may request to participate in the event. In some embodiments, the enrollment request may comprise demographic information of the potential event participant, location of the potential event participant, an event time of the potential event participant, an event type preferred by the potential event participant, and skill level preferred by the potential event participant. In some embodiments, the event system may receive real-world location information specifying a real-world location of the potential event participant.

In some embodiments, the event system may be configured to determine event eligibility of the user. For example, event eligibility may be determined by comparing the event location to the location of the potential event participant, the event time to the event time preferred by the potential event participant, the event type to the event type preferred of the potential event participant, and participation requirement to the skill level of the potential event participant.

In some embodiments, upon determining event eligibility of potential event participant, the event system may be configured enroll the potential event participant in the event.

### BRIEF DESCRIPTION OF THE DRAWINGS

FIG. 1 illustrates an event system comprising an event platform, according to an implementation of the disclosure.

FIG. 2 illustrates a user information screen within the event platform of the event system of FIG. 1, according to an implementation of the disclosure.

FIG. 3A illustrates an event information screen within the event platform of the event system of FIG. 1, according to an implementation of the disclosure.

FIG. 3B illustrates an event selection screen within the event platform of the event system of FIG. 1, according to an implementation of the disclosure.

FIG. 4 illustrates an event notification screen within the event platform of the event system of FIG. 1, according to an implementation of the disclosure.

FIG. 5 illustrates an event participation screen within the event platform of the event system of FIG. 1, according to an implementation of the disclosure.

FIG. 6 illustrates a process for generating criteria-based events, according to an implementation of the disclosure.

FIG. 7 illustrates an example computing system that may be used in implementing various features of embodiments of the disclosed technology.

### DETAILED DESCRIPTION

Described herein are systems for generating events within a geographic location based on user-specified criteria. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

As alluded to above, users may be interested in organizing events opened to participants with a particular level of skill or ability. For example, a user may be interested in playing a game of soccer near their home with individuals that are proficient in soccer.

In accordance with various embodiments, a user can generate events by specifying event criteria. For example, the user can specify number of parameters related, for example to time of event, location of event, duration of event, event type, participant number, participant type, participant skill level, and other such parameters. organize and manage

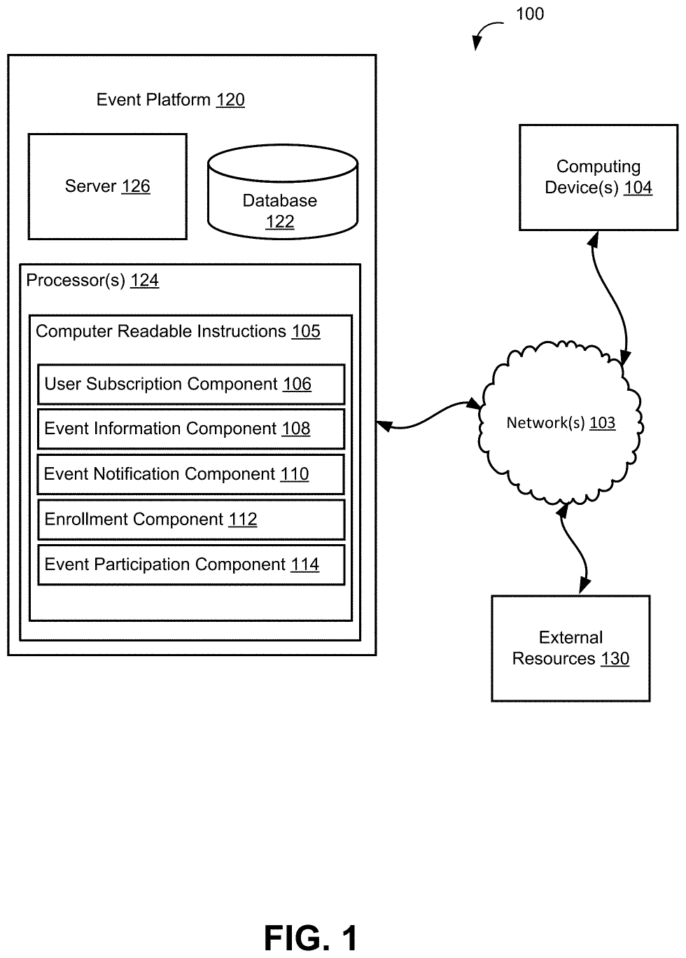

FIG. 1 illustrates an example event system 100 configured in accordance with one embodiment. The event system 100 or components/features thereof may be implemented in combination with, or as an alternative to, other systems/features/components described herein, such as those described with reference to other embodiments and figures. The event system 100 may additionally be utilized in any of the methods for using such systems/components/features described herein. The event system 100 may also be used in various applications and/or permutations, which may or may not be noted in the illustrative embodiments described herein. For instance, event system 100 may include more or less features/components than those shown in FIG. 1, in some embodiments. Moreover, the event system 100 is not limited to the number of components, etc. specifically shown in FIG. 1, although one or more aspects of event system 100 may have particular component constraints in certain embodiments, as these one or more aspects may impact the detection capabilities of event system 100.

In some embodiments, and as shown in FIG. 1, the event system 100 may comprise an event platform 120 configured to generate events based on one or more user specified parameters, as alluded to above. The event platform 120 may include one or more servers 126. For example, the server 126 may be configured to communicate with one or more client computing devices 104 according to a client/server architecture.

In some embodiments, the users of event system 100 (e.g., event organizers and/or event participants) may access the event platform 120 via client computing devices(s) 104. The users of event system 100 (e.g., event organizers and event participants) may access server 126 which may include one or more processors 124 configured to execute one or more computer program components. In some embodiments, the computer program components may include one or more of a subscription component 106, an event information component 108, an event notification component 110, an enrollment component 112, an event participation component 114, and/or other such components.

In some implementations, event platform 120, client computing devices 104, and/or external resources 130 may be operatively linked via one or more electronic communication links. For example, such electronic communication links may be established, at least in part, via a network 103 such as the Internet and/or other networks. It will be appreciated that this is not intended to be limiting, and that the scope of this disclosure includes implementations in which server(s) 102, client computing platform(s) 104, and/or external resources 130 may be operatively linked via some other communication media.

In some embodiments, external resources 130 may comprise one or more performance tracking repositories provided by one or more external agencies or systems. The performance repository may include one or more servers, processors, and/or databases that can store performance related information, e.g., skill level, performance history, event history, scores, statistics, and other such information provided by one or more external systems. The performance related information may be used by the event platform 120 to determine and/or verify participant eligibility, as will be described in detail below.

In some embodiments, client computing device 104 may be equipped with GPS location tracking and may transmit geolocation information via a wireless link and network 103 to system 100. In some embodiments, event system 100 may use the geolocation information to determine a geolocation associated with users of the event system 100. Event system 100 may use signal transmitted by client computing device 104 to determine the geolocation of a user based on one or more of signal strength, GPS, cell tower triangulation, Wi-Fi location, or other input. In some embodiments, the geolocation associated with the user may be used by one or more computer program components (e.g., event information component 108, an event notification component 110, an enrollment component 112, and event participation component 114) during the event generation process.

In some embodiments, a user may register and set up an account with event platform 120. The user may input information associated with and/or relevant to the user via user subscription component 106, such as user information specifying user demographic characteristics (e.g., age, gender, occupation, and so on). In some embodiments, the user may enter a geographic location the user the be interested in either organizing an event or participating in an event. In some embodiments, the user may input information associated with activities and/or events the user may be interested in organizing or participating. For example, the user may either specify types or categories of activities or events, or input a specific activity or event, or both.

In some embodiments, the user may input information associated with their level of skill, experience, and/or proficiency with a certain activity or event. For example, the user may indicate a number of years they have been involved with a particular activity (e.g., number of years playing a sport or number of years mountain climbing), a level of skill they posses (e.g., beginner, intermediate, advanced), achievements associated with a particular activity (e.g., number of games won or challenging routes completed). In some embodiments, the user may specify one or more external agencies and/or systems that can be used to verify user's performance related information (e.g., skill level, performance history, event history, scores, statistics, and other such information), as will be discussed in greater detail below.

In some embodiments, as alluded to above, the user may access the event platform 120 via a client computing devices 104 via a user interface (not shown). For example, the client computing device 104 may be a desktop computer or a mobile device (e.g., a tablet computing device a cellular phone). The interface may be used by users (e.g., event organizers and event participants) to receive and transmit information to the event platform 120 via a communication network 103, as explained above.

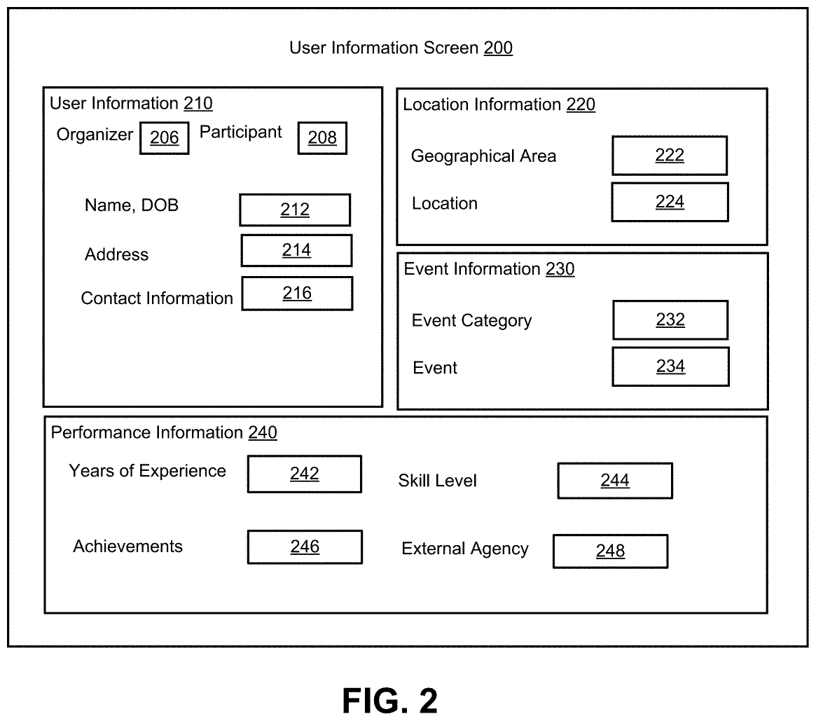

In some embodiments, the user subscription component 106 may be configured to generate a user subscription form configured to receive user input. For example, and as illustrated in FIG. 2, a user subscription screen 200 may be configured to receive user information 210, location information 220, performance information 230, and/or other similar user input. In some embodiments, the user subscription component 106 may be configured to generate a profile for each user that provides user information 210.

In some embodiments, subscription component 106 may be configured to receive user input indicating user status, i.e., whether user intends to be an organizer or a participant, or both. For example, user may indicate their intent to be event organizer via input field 206 or event participant via input field 208. In some embodiments, the user subscription component 106 may be configured to receive user information 210 including user biometric information. For example, a user may provide their name and date of birth via input field 212 within the user subscription screen 200. Similarly, user may provide address, and contact information, via input fields 214, 216, respectively.

In some embodiments, the user subscription component 106 may be configured to receive user input related to one or more locations where user is interested in participating in events or organizing events. For example, user may input location information 220 associated with events or activities by inputting a geographical area via input field 222 (e.g., a particular neighborhood or city). In some embodiments, user may input location information 220 associated with events or activities by inputting a particular location via input field 224 (e.g., a particular destination or landmark).

In some embodiments, the user subscription component 106 may be configured to receive user input related to one or more events or activities that user is interested in participating or organizing. For example, user may input event information 230 associated with an event or activity by inputting event category information via input field 232. In some embodiments, an event category may include one or more activities or events. For example, an event category of team sports may include activities such as softball, soccer, basketball, and so on. In some embodiments, user may input event information 230 associated with events or activities by inputting a particular event or activity via input field 234 (e.g., soccer).

In some embodiments, the user subscription component 106 may be configured to receive user input related to their performance level associated with one or more activities that user is interested in participating or organizing. For example, user may input performance information 240 associated with a particular activity by inputting number of years they have been participating in that activity, their skill level, and their achievements via input fields 242, 244, and 246, respectively.

In some embodiments, user may link their account within event platform 120 with one or more outside agencies or organizations configured to store data related to user's performance. In some embodiments, user may input external agency information configured to track user performance (e.g., skill level, performance history, event history, scores, statistics, and other such information), as alluded to earlier. For example, the user may provide external agency information by inputting information related to a particular agency via input field 248. In some embodiments, the event platform 120 may access the external agency information provided by the user to validate their performance level during participant eligibility determination, as will be described in detail below. For example, event platform 120, using, e.g., an application programming interface (API), may transmit an inquiry comprising user information to verify and/or obtain user performance information.

In some embodiments, a user that has registered as an event organizer, as alluded to above, may access the event platform 120 via a user interface (not shown) to create an event. In some embodiments, the organizer may provide one or more parameters during event planning and/or creating process. For example, the organizer may specify one or more parameters such as a type of event or activity, time, location, desired skill level of participants, and number of participants.

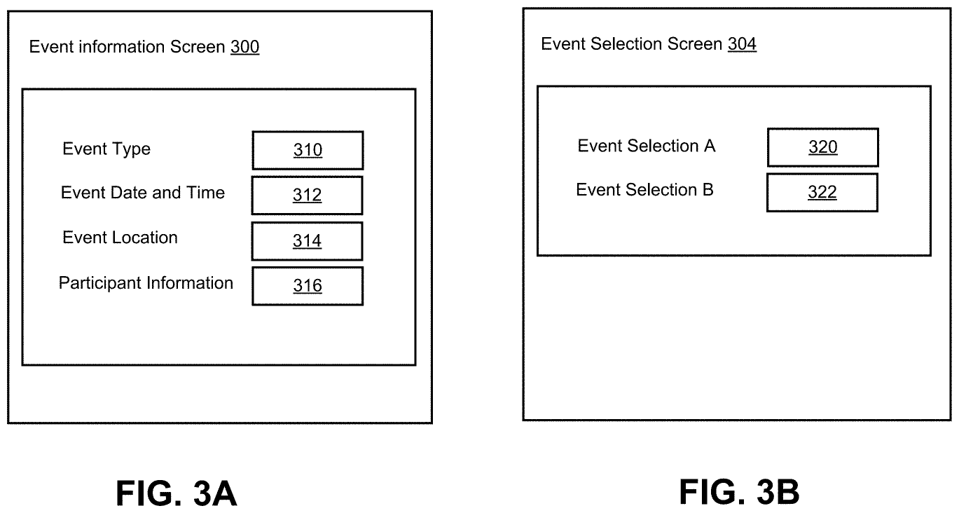

In some embodiments, the event information component 108 may be configured to generate an event entry form configured to receive user (e.g., event organizer) input during an event planning process. For example, and as illustrated in FIG. 3A, an event information screen 300 may be configured to receive event type information 310, event date and time information 312, event location information 314, and participant information 316 including number of participants and their skill level, and/or other similar user input.

In some embodiments, the event information component 108 may be configured to determine one or more event details based on user-specified event parameters provided by the organizer via the event information screen 300. For example, the event information component 108 may receive user input event for category information specifying team sports and event time specifying Saturday, 11 AM, and event location specifying an area equal to a 10 mile radius around user's home. In some embodiments, the event information component 108 may receive user's geographic location transmitted by their client communication device 104, as alluded to earlier. Based on this information, the event information component 108 may determine that the only available venues on Saturday at 11 AM, located within a 10 mile radius and suitable for playing a team sport is are basketball court and a softball field.

In some embodiments, the event information component 108 may be configured to generate one or more event selections based on user-specified event parameters provided by the organizer via the event information screen 300. For example, once the event organizer inputs event information, as alluded to above, the event information component 108 may present user with one or more event selections. In some embodiments, and as illustrated in FIG. 3B, an event selection screen 304 may be configured to receive user input (e.g., event selection A or event selection B) by providing user input via entry fields 320, 322, respectively. For example, and using the example above, a first event selection (e.g., event selection A) may include a basketball game and a second event selection (e.g., event selection B) may include a softball game. In some embodiments, the event organizer may select the one or more event selection generated by the event information component 108.

In some embodiments, the participant information may be specified by the event organizer, as alluded to above, by entering participant information 316 via event information screen 300. In some embodiments, the event information component 108 may determine participant information based on other user-specified event parameters provided by the organizer via the event information screen 300. For example, upon selecting a particular event selection (e.g., event selection A) associated with a particular event such as a basketball game, the event information component 108 may determine a maximum and minimum number of participants required to play a game of basketball. In some embodiments, the event information component 108 may determine that participant requirements based on other user-specified event parameters provided by the organizer via the event information screen 300. For example, upon receiving participant skill level as intermediate specified by the event organizer, event information component 108 may determine that only participants having a skill level corresponding to intermediate skill level may enroll in the event, as will be described in detail below.

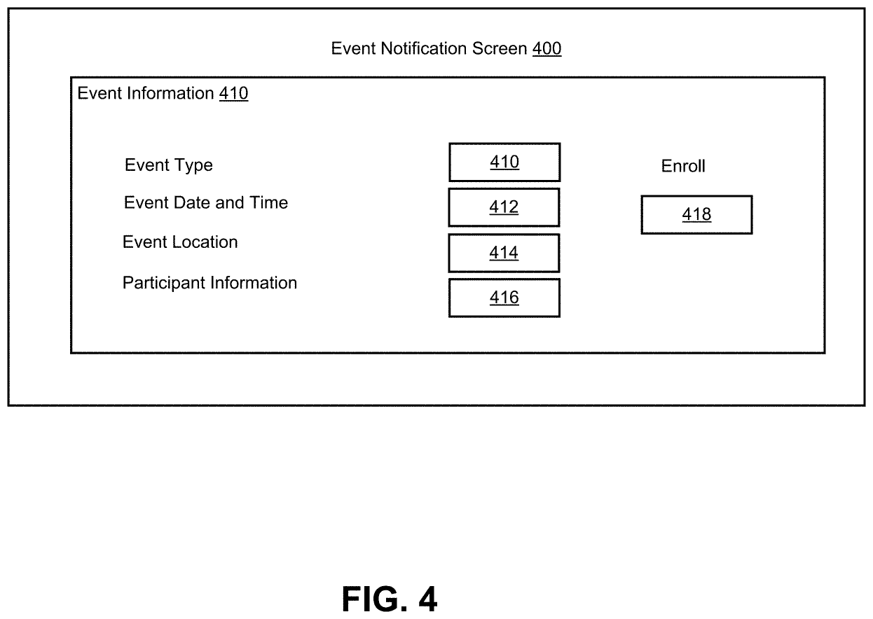

In some embodiments, upon receiving event selection inputted by event organizer, the event information component 108 may be configured to transmit information to event notification component 110. In some embodiments, event notification component 110 may be configured to generate an event notification associated with a participant event selection made by the event organizer. In some embodiments, the event notification component 110 may be configured to transmit the event notification to one or more users (i.e., potential event participants). For example, and as illustrated in FIG. 4, an event notification screen 400 may be configured to display event type information 410, event date and time information 412, event location information 414, and participant information 416 including number of participants and their skill level. In some embodiments, the event notification may be transmitted to users registered with the event platform 120 by supplying user information via user subscription component 106, as alluded to above. Alternatively, the event notification may be transmitted only to those participants whose user information provided via user subscription component 106 match event information provided by the event organizer via event information component 108. For example, the event notification including information associated with a particular event such as a basketball game at a particular location at a particular type that requires participants to have a skill level corresponding to intermediate skill level may be transmitted to users that have specified as being interested in playing basketball at that particular location and at that particular time and that also have a skill level corresponding to intermediate skill level. Alternatively, the event notification component 110 may be configured to transmit an event notification generated by the event information component 108 to one or more participants that the organizer may have provided.

In some embodiments, the event notification component 110 may be configured to transmit the event notification to one or more users the organizer may be associated with in one or more social networks. For example, event platform 120, using, e.g., an application programming interface (API), may obtain user information from one or more social network accounts associated with the event organizer.

In some embodiments, participants may view one or more event notifications transmitted by event notification component 110, as alluded to above. In some embodiments, the user receiving the event notification transmitted via the event notification component 110 may enroll in an event specified in the event notification. For example, as illustrated in FIG. 4, an event notification screen 400 may be configured to accept user response by accepting user input via entry field 418. In some embodiments, user response received may be transmitted to enrollment component 112.

In some embodiments, the enrollment component 112 may be configured to determine participant eligibility. For example, upon receiving enrollment request from the user, the enrollment component 112 may verify user skill level by transmitting an inquiry comprising user information to one or more external agencies.

In some embodiments, upon receiving a verification that the user skill level corresponds to the skill level indicated by the event organizer the enrollment request may be transmitted by the enrollment component 112 to the event organizer. In some embodiments, event organizer may view all users that have requested enrollment in the event and select users that they wish to admit into the event. For example, the user may use user skill level and/or other performance information to determine enrollment.

In some embodiments, users that have requested enrollment in the event may be enrolled in the event automatically. In some embodiments, users that have been selected by the event organizer may receive a notification indicating their enrollment. In some embodiments, upon completing the enrollment of a number of users corresponding to a number users indicated in the event information parameter, the enrollment component 112 may reject user request to enrollment in the event. In some embodiments, user that were not selected by the event organizer may receive a notification informing them that they were not selected to participate in the event.

In some embodiments, the event system 100 may be configured to track participation of users enrolled in the event. For example, client computing device 104 associated with users that have been enrolled in the event may be equipped with GPS location tracking and may transmit geolocation information via a wireless link and a communications network to the event platform 120 of event system 100. In some embodiments, event platform 120 may use the geolocation information to determine a geolocation associated with individual users enrolled in the event. For example, event platform 120 may use signal transmitted by client computing device 104 to determine the geolocation of each of the enrolled user based on one or more of signal strength, GPS, cell tower triangulation, Wi-Fi location, or other input. In some implementations, movements of each of the enrolled user may be tracked using a geography-based transmitter on client computing device 104.

In some embodiments, event participation component 114 may be configured to determine user participation by verifying whether user's geographic location determined by the event platform 120, as alluded to above, confirms to the event location at the event time. For example, users whose client computing device 104 indicates that they are not located at the event location at the event time will be deemed as having missed the event.

In some embodiments, event participation component 114 may be configured to obtain additional metrics associated with user participation in the event. For example, duration of user's participation and speed with which they are moving during the event may be obtained.

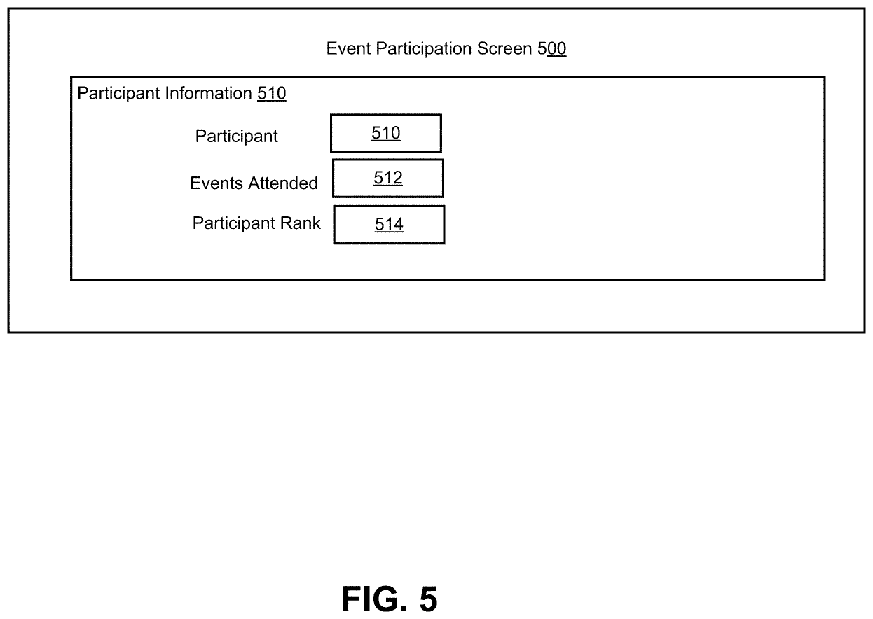

In some embodiments, event participation component 114 may be configured to rank and/or rate users enrolled in the event. For example, attendance may be used to rank individual users by the event system 100. In some embodiments, and as illustrated in FIG. 5, user participant information 510 may be viewed via event participation screen 500. In some embodiments, participant information 510 may include participant name 510, events attended by the participant 512, and participant rank 514, determined by the event system 100, as alluded to above.

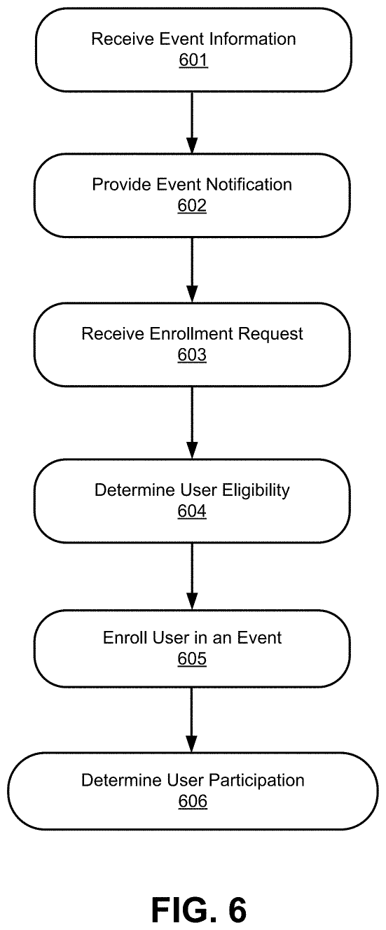

FIG. 6 illustrates a flow chart describing various processes that can be performed in order to generate events by an event system in accordance with another embodiment. For example, at operation 601, event information may be received. The event information may include user specified parameters (e.g., event type, event location, event time, and participant requirements). The event information may be used to transmit event notifications to one or more users of the event system 100, at operation 602.

At operation 603, the system may receive event enrollment request from a user that has received an event notification. Upon receiving an event enrollment request, user's eligibility to participate in the event may be determined, at operation 604. Upon determining user edibility, users may be enrolled in the event by, at operation 605. At an operation 606, the user participation may be determined by using on one or more of signal strength, GPS, cell tower triangulation, Wi-Fi location, or other input.

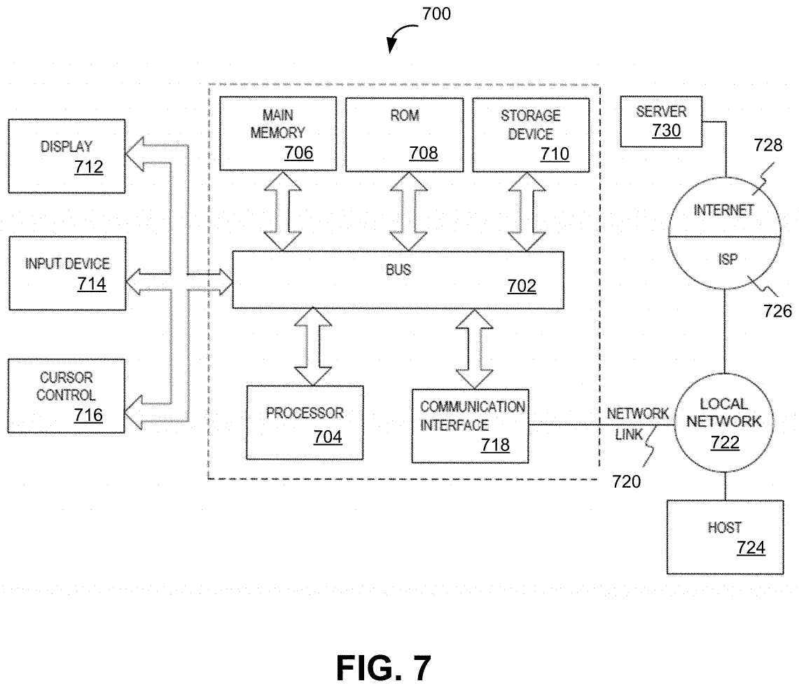

FIG. 7 illustrates an example computing module 700, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 700. After reading this description, it will become apparent to a person skilled in the relevant art how to implement the application using other computing modules or architectures.

Referring now to FIG. 7, computing module 700 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 700 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 700 might include, for example, one or more processors, controllers, control modules, or other processing devices, such as a processor 704. Processor 704 might be implemented using a general-purpose or special-purpose processing engine such as, for example, a microprocessor, controller, or other control logic. In the illustrated example, processor 704 is connected to a bus 702, although any communication medium can be used to facilitate interaction with other components of computing module 700 or to communicate externally.

Computing module 700 might also include one or more memory modules, simply referred to herein as main memory 708. For example, preferably random access memory (RAM) or other dynamic memory might be used for storing information and instructions to be executed by processor 704. Main memory 708 might also be used for storing temporary variables or other intermediate information during execution of instructions to be executed by processor 704. Computing module 700 might likewise include a read only memory (“ROM”) or other static storage device coupled to bus 702 for storing static information and instructions for processor 704.

The computing module 700 might also include one or more various forms of information storage devices 710, which might include, for example, a media drive 712 and a storage unit interface 720. The media drive 712 might include a drive or other mechanism to support fixed or removable storage media 714. For example, a hard disk drive, a floppy disk drive, a magnetic tape drive, an optical disk drive, a CD or DVD drive (R or RW), or other removable or fixed media drive might be provided. Accordingly, storage media 714 might include, for example, a hard disk, a floppy disk, magnetic tape, cartridge, optical disk, a CD or DVD, or other fixed or removable medium that is read by, written to or accessed by media drive 712. As these examples illustrate, the storage media 714 can include a computer usable storage medium having stored therein computer software or data.

In alternative embodiments, information storage devices 710 might include other similar instrumentalities for allowing computer programs or other instructions or data to be loaded into computing module 700. Such instrumentalities might include, for example, a fixed or removable storage unit 722 and a storage unit interface 720. Examples of such storage units 722 and storage unit interfaces 720 can include a program cartridge and cartridge interface, a removable memory (for example, a flash memory or other removable memory module) and memory slot, a PCMCIA slot and card, and other fixed or removable storage units 722 and interfaces 720 that allow software and data to be transferred from the storage unit 722 to computing module 700.

Computing module 700 might also include a communications interface 724. Communications interface 724 might be used to allow software and data to be transferred between computing module 700 and external devices. Examples of communications interface 724 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 724 might typically be carried on signals, which can be electronic, electromagnetic (which includes optical) or other signals capable of being exchanged by a given communications interface 724. These signals might be provided to communications interface 724 via a channel 728. This channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 708, storage unit interface 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 700 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for generating event requests, the system comprising:
one or more processors configured by machine-readable instructions to:
receive, via an event application, event information corresponding to an event, the event information specifying a set of user-specific parameters;
generate, via the event application, an event based on the set of user-specific parameters;
generate, via the event application, a notification to a first user, the notification comprising the event information;
receive, via the event application, an enrollment request from the first user, the enrollment request requesting participation in the event;
upon determining event eligibility of the first user, enroll the first user in the event;
wherein the event information is received from a second user that is different from the first user.

2. The system of claim 1, further comprising receiving, via the event application, real-world location information specifying a real-world location of the second user.

3. The system of claim 2, wherein the set of user-specific parameters comprise an event location, an event time, and event type, and a participation requirement.

4. The system of claim 3, wherein the event location is determined by the real-world location of the second user.

5. The system of claim 3, wherein the enrollment request comprises demographic information of the first user, user location information specifying location of the first user, an event time specifying preferred event time by the first user, an event type specifying preferred event type by the first user, and skill level of the first user.

6. The system of claim 5, wherein event eligibility is determined by comparing the event location to the location of the first user, the event time to the event time of the first user, the event type to the event type of the first user, and participation requirement to the skill level of the first user.

7. The system of claim 6, wherein the event type comprises one or more event categories.

8. The system of claim 1, wherein enrolling the first user comprises transmitting, via the event application, an enrollment notification to the first user.

9. The system of claim 1, further comprising receiving, via the event application, real-world location information specifying a real-world location of the first user.

10. The system of claim 9, further comprising determining, via the event application, participation of the first user by using the real-world location of the first user.

11. A method for generating event requests, the method comprising:
receiving, via an event application, event information corresponding to an event, the event information specifying a set of user-specific parameters;
generating, via the event application, an event based on the set of user-specific parameters;
generating, via the event application, a notification to a first user, the notification comprising the event information;
receiving, via the event application, an enrollment request from the first user, the enrollment request requesting participation in the event;
upon determining event eligibility of the first user, enrolling the first user in the event;
wherein the event information is received from a second user that is different from the first user.

12. The method of claim 11, further comprising receiving, via the event application, real-world location information specifying a real-world location of the second user.

13. The method of claim 12, wherein the set of user-specific parameters comprise an event location, an event time, and event type, and a participation requirement.

14. The method of claim 13, wherein the event location is determined by the real-world location of the second user.

15. The method of claim 13, wherein the enrollment request comprises demographic information of the first user, user location information specifying location of the first user, an event time specifying preferred event time of the first user, an event type specifying preferred event type of the first user, and skill level of the first user.

16. The method of claim 15, wherein event eligibility is determined by comparing the event location to the location of the first user, the event time to the event time of the first user, the event type to the event type of the first user, and participation requirement to the skill level of the first user.

17. The method of claim 16, wherein the event type comprises one or more event categories.

18. The method of claim 11, further comprising receiving, via the event application, real-world location information specifying a real-world location of the first user.

19. The method of claim 18, further comprising determining, via the event application, participation of the first user by using the real-world location of the first user.
